(19) United States
(12) Patent Application Publication
(10) Pub. No.: US 2026/0178625 A1
(43) Pub. Date: Jun. 25, 2026

(54) MULTIMODAL MODEL CUSTOMIZATION AND ORCHESTRATION

(71) Applicant: MICROSOFT TECHNOLOGY LICENSING, LLC, Redmond, WA (US)

(72) Inventors: Julia GONG, Bellevue, WA (US); Kuan LU, Los Gatos, CA (US); Houdong HU, Kirkland, WA (US); Adina Magdalena TRUFINESCU, Redmond, WA (US); Günter NOGUEIRA LOCH, Redmond, WA (US); Tong BAI, Bellevue, WA (US); Georgios GEORGIADIS, Kirkland, WA (US); Nishant YADAV, Reno, NV (US); Pei GUO, Redmond, WA (US); Jun PAN, Redmond, WA (US); Chongyang BAI, Qingtongxia, Ningxia (CN); Cha ZHANG, Bellevue, WA (US)

(21) Appl. No.: 18/991,229

(22) Filed: Dec. 20, 2024

(51) Int. Cl. G06F 16/3329; G06F 16/332; G06T 11/00

(52) U.S. Cl. CPC G06F 16/33295; G06F 16/3326; G06T 11/00

(57) ABSTRACT

Customized multimodal task models implement processing flows orchestrated by model customization agents that identify and modify task definitions based on multimodal user inputs. A task is selected to be performed by the customized multimodal task model based on user input that is received, labeled and compared with indexed task definitions of possible tasks. An inference contract for the selected task is created and optionally modified by presenting a proposed task definition for the selected task and obtaining new user input that at least confirms the proposed task definition or that supplements the initial user input for modifying the proposed task definition. An execution processing flow of the customized multimodal task model is created to implement the inference contract. The execution processing flow may be modified based on user feedback directed at inferenced images to improve the customized task model.

### BACKGROUND

The field of machine learning and artificial intelligence (AI) has seen significant advancements in recent years, particularly in the development and deployment of vision models. These models are widely used in various industries for tasks such as object detection, image classification, and facial recognition. Despite their widespread adoption, the process of customizing vision models to meet specific user requirements remains a complex and resource-intensive task. Users often need to have a deep understanding of machine learning concepts and possess the technical expertise to fine-tune models for their particular use cases.

One of the primary challenges in the industry is the need for extensive labeled data to train and customize multimodal models. Acquiring and annotating large datasets is both time-consuming and costly, often requiring manual effort from domain experts. Additionally, the iterative process of refining models based on user feedback can be cumbersome, as it involves multiple rounds of training, validation, and testing. This complexity is further compounded by the need to integrate various model components and orchestrate them into a cohesive pipeline that can effectively perform the desired tasks.

Another significant issue is the high computational cost associated with deploying and serving large vision models. These models often require substantial computational resources, making them expensive to run, especially in real-time applications. The industry is continually seeking ways to reduce these costs while maintaining or improving model performance. Techniques have been explored to address this challenge. However, implementing these techniques in a flexible and customizable way remains a challenge.

The customization and deployment of vision models can be difficult and non-intuitive, especially for non-experts. The lack of user-friendly interfaces and tools for guiding users through model customization processes hinders the broader adoption of AI technologies.

In view of the foregoing, it will be appreciated that there is an ongoing need and desire in the AI industry for improved systems and techniques that can utilized to simplify the deployment and customization of vision models.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed and claimed embodiments include systems, methods and devices for facilitating the generation of customized and customizable multimodal models.

Disclosed methods for generating a customized multimodal task model include a computing system selecting a task to be performed based on initial user input that contains multiple types of input, such as image data and language data associated with a task to be performed, the multiple types of input can also include other combinations of input data, such as combinations of audio, speech, video, text and/or image data. Labeled input data is generated on the multiple types of input data. This includes, in some instances, performing natural language processing on the language data and image processing on the image data. A single unified model may also be utilized to perform all of the labeling processing for all types of input modalities.

Once the labeled input data is generated, the computing system selects the task to be performed from a plurality of possible tasks by comparing the labeled input data with indexed task definitions of the plurality of possible tasks. Each of the indexed task definitions include task attributes including input and output formats for the different tasks.

In some aspects, an inference contract is created for the selected task by the computing system iteratively presenting a prompt at a user interface that identifies a proposed task definition for the selected task and obtaining new user input that at least confirms the proposed task definition or that supplements the initial user input for modifying the proposed task definition.

In some aspects, the multimodal model comprises a vision model and the techniques for generating the customized multimodal model also include generating an execution processing flow of the customized multimodal task model to implement the inference contract, presenting user access to the customized multimodal task model, generating inferenced content (e.g., images) by performing inferencing on new content (e.g., new input images) with the customized task model according to the execution processing flow, receiving user feedback based on the inferenced content (e.g., images), and modifying the execution processing flow based on the user feedback to improve the customized task model.

In some aspects, the techniques described herein relate to a method, wherein the method further includes identifying and presenting suggested modifications to the proposed task definition based on identified contextual information.

In some aspects, the techniques described herein relate to a method, wherein the method further includes modifying the execution processing flow based on user input responsive to the suggested modifications.

In some aspects, the techniques described herein relate to a method, wherein the method further includes storing the inferenced content (e.g., images) generated during the inferencing in a user dataset, receiving user input for accessing the user dataset; presenting the inferenced content (e.g., images) from the user dataset, receiving user input directed at the inferenced content (e.g., one or more of the inferenced images), and modifying the execution processing flow based on the user input directed at the inferenced content.

In some aspects, computing systems include one or more hardware processors and hardware storage storing computer-executable instructions that are executable by the hardware processor(s) to implement the functionality and methods disclosed herein.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment that includes a computing system in communication with one or more user and third-party systems for facilitating the generation of customized multimodal task models. The computing system includes and/or may be used to implement the disclosed embodiments.

FIGS. 2A-2J illustrate example interactions between a user and a model customization agent through a user interface during the identification of a task and the generation of a customized multimodal task model capable of performing the task.

FIGS. 3A-3B illustrate examples of a user dataset that includes inferenced images generated by the customized vision task model referenced in FIGS. 2A-2J.

FIG. 4 illustrates a flowchart of acts associated with example methods for generating a customized multimodal task model.

### DETAILED DESCRIPTION

Disclosed and claimed embodiments include systems, methods and devices for facilitating the generation of customized multimodal task models.

The customized multimodal task models implement processing flows orchestrated by model customization agents that identify and modify task definitions based on multimodal user inputs. Tasks are selected to be performed by the customized multimodal task models based on user input that is received, labeled and compared with indexed task definitions of possible tasks. Inference contracts for the selected tasks are created and optionally modified through the formalization of task definitions and input/output taxonomies for the selected tasks. Execution processing flows of the customized multimodal task models are created to implement the inference contracts. The execution processing flows can be modified based on user feedback directed at inferenced images to improve the functions of the customized task models.

Beneficially, the disclosed embodiments can be utilized to provide various technical improvements in the technical field of multimodal models and applied artificial intelligence. In particular, the disclosed and claimed embodiments can be utilized to generate customized multimodal models capable of performing tasks that are defined, in part, by multimodal inputs. Even more particularly, the customized multimodal task models implement processing flows orchestrated by model customization agents that identify and modify task definitions and the corresponding input/output taxonomies based on multimodal user inputs. In this manner, users are provided with improved flexibility for creating and modifying multimodal models to perform desired tasks, based on desired input and output formatting. Additional benefits and practical advantages of the disclosed methods for generating customized multimodal task models will be more apparent from the following descriptions.

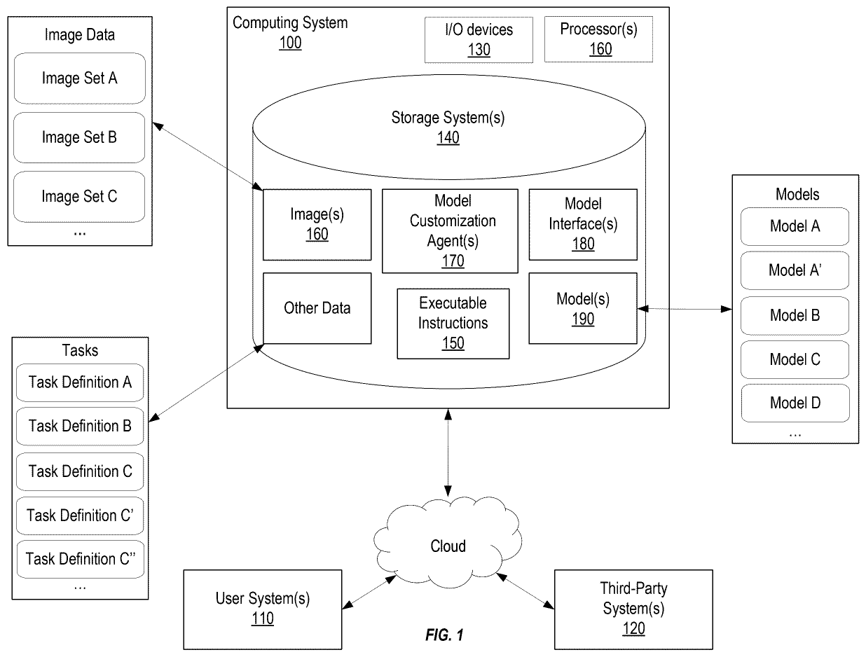

FIG. 1 illustrates a computing system 100 which can be utilized to facilitate the generation and modification of customized multimodal task models.

As shown, a computing system 100 is in communication with one or more user system(s) 110 and/or third-party system(s) 120. In some implementations, the user system(s) 110 and third-party system(s) 120 are remotely located from the computing system 100 and are independently controlled computing systems. In other implementations, the user system(s) 110 and/or third-party system(s) 120 comprise distributed components of the computing system 100, such that they share storage and processing capabilities.

Computing system 100 is connected to the other user system(s) 110 and third-party system(s) 120 through a network of wired and/or wireless connections, such as currently represented as the cloud.

Each of the illustrated systems includes input and output devices (I/O devices 130) for receiving multimodal inputs and rendering outputs, respectively, even though they are only explicitly shown for computing system 100. Non-limiting examples of input devices include microphones, keyboards, mouse devices, touch pads, and camera sensors. Non-limiting examples of output devices include speakers, desktop display screens, mixed-reality display devices, and haptic feedback devices.

The disclosed systems also include one or more storage system(s) 140 of volatile and/or non-volatile storage and one or more hardware processor(s) configured to execute the executable instructions 160 stored in the storage system(s) 140 to cause the computing system 100 to implement the methods and functionality disclosed herein.

The storage system(s) 140 also store the image(s) 160, model customization agent(s) 170, model interface(s) 180 and model(s) 190 that are described herein, as well as the other data that is described and utilized to implement the functionality described herein.

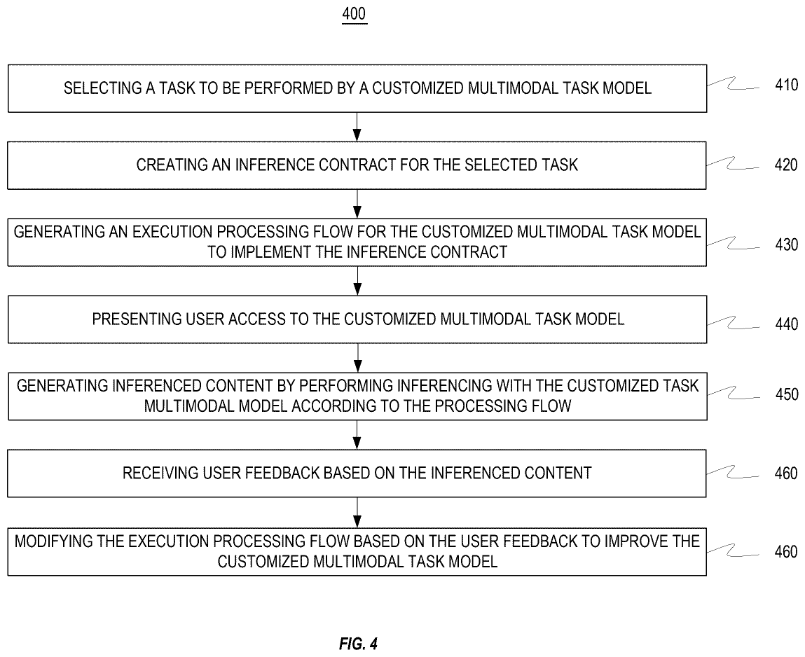

As disclosed herein, the computing systems of FIG. 1 can be utilized to implement the disclosed methods and acts described herein, such as the acts of flowchart 400 that are illustrated in FIG. 4, for generating various types of customized multimodal task models for performing different types of tasks.

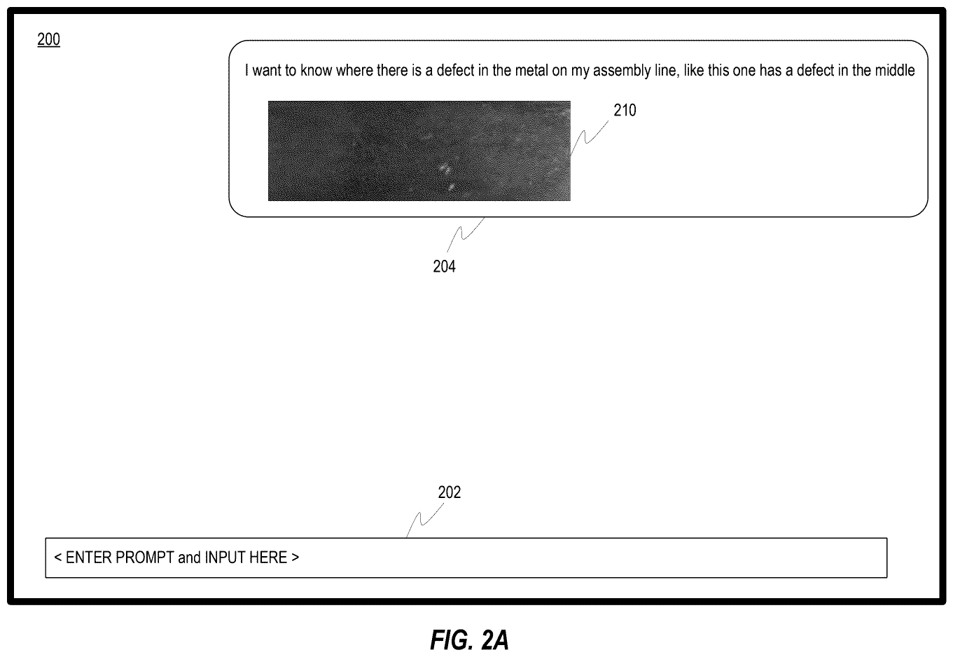

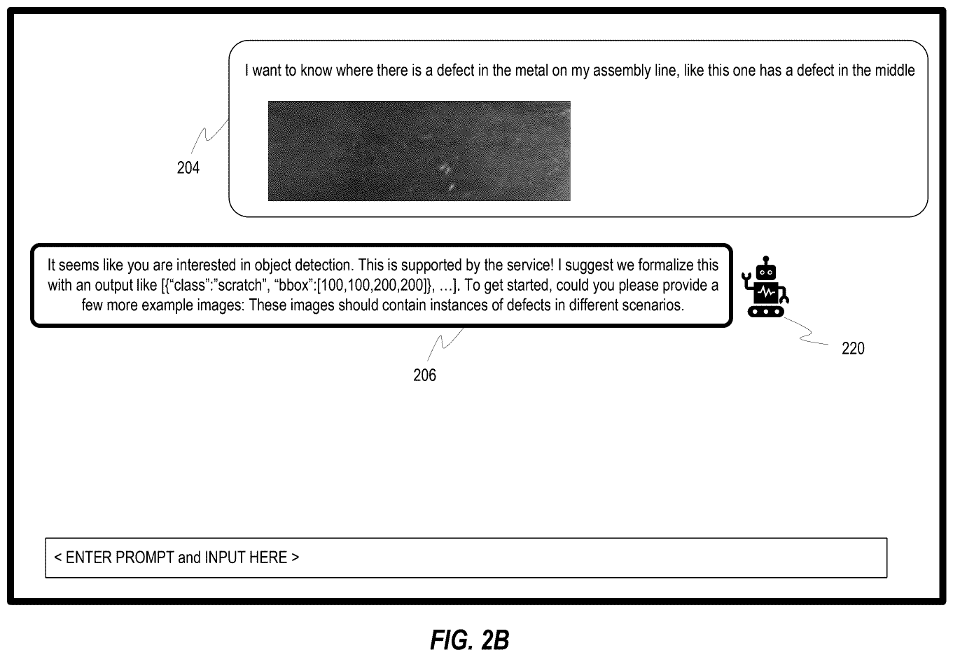

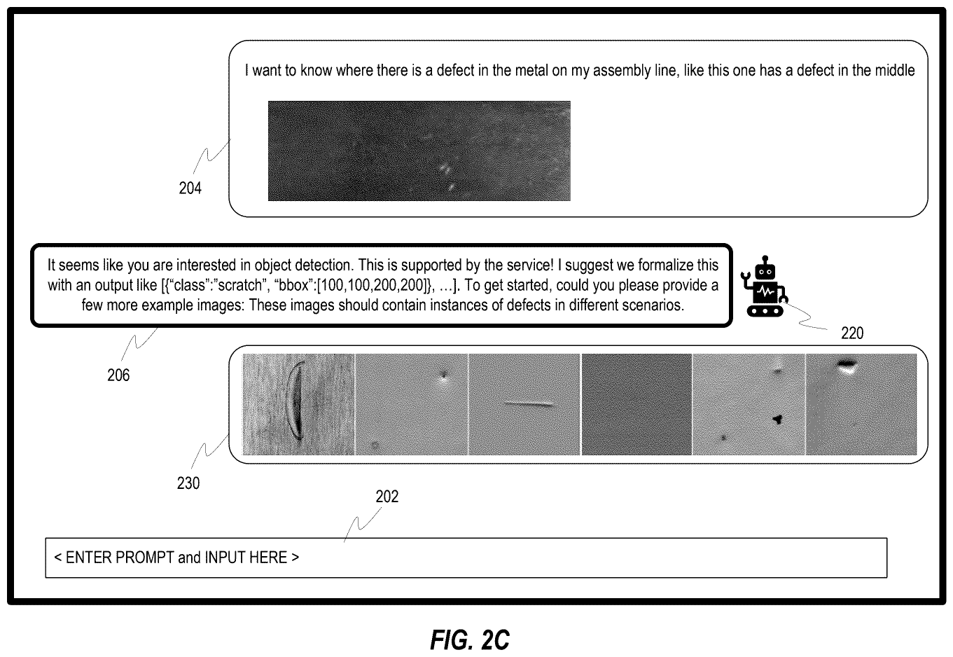

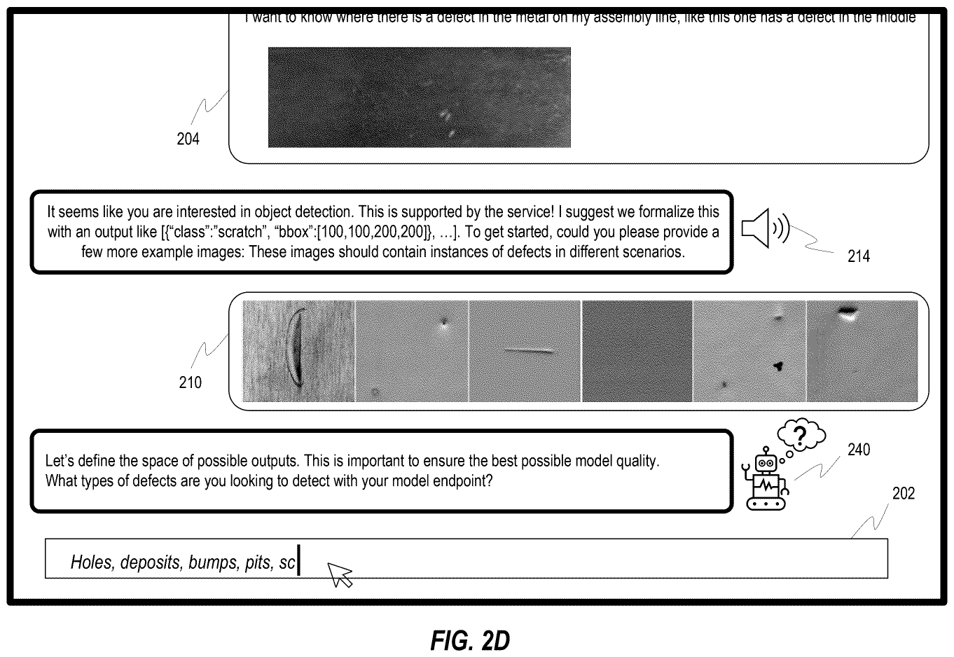

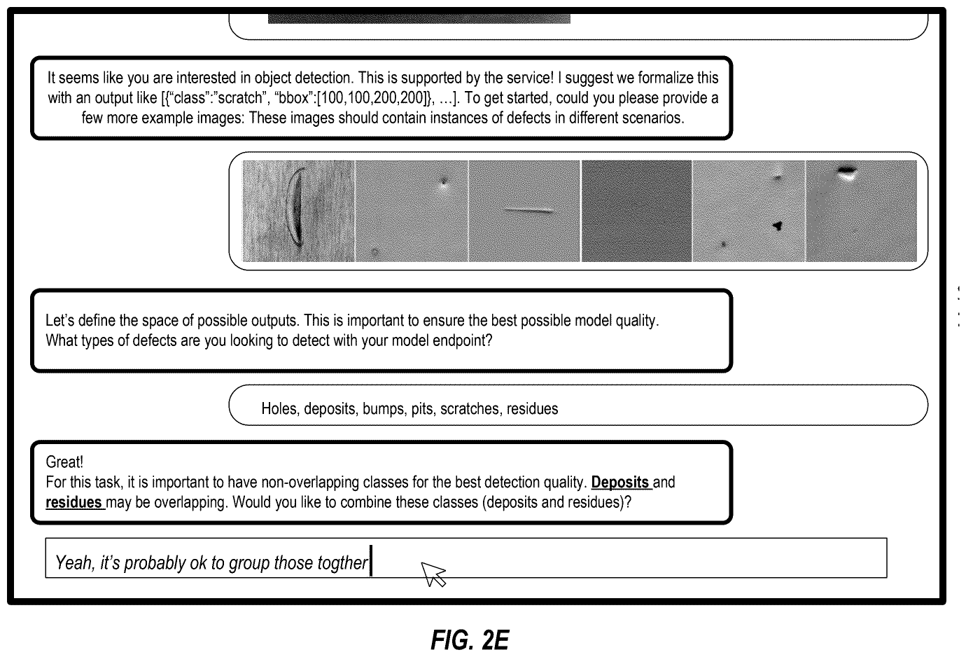

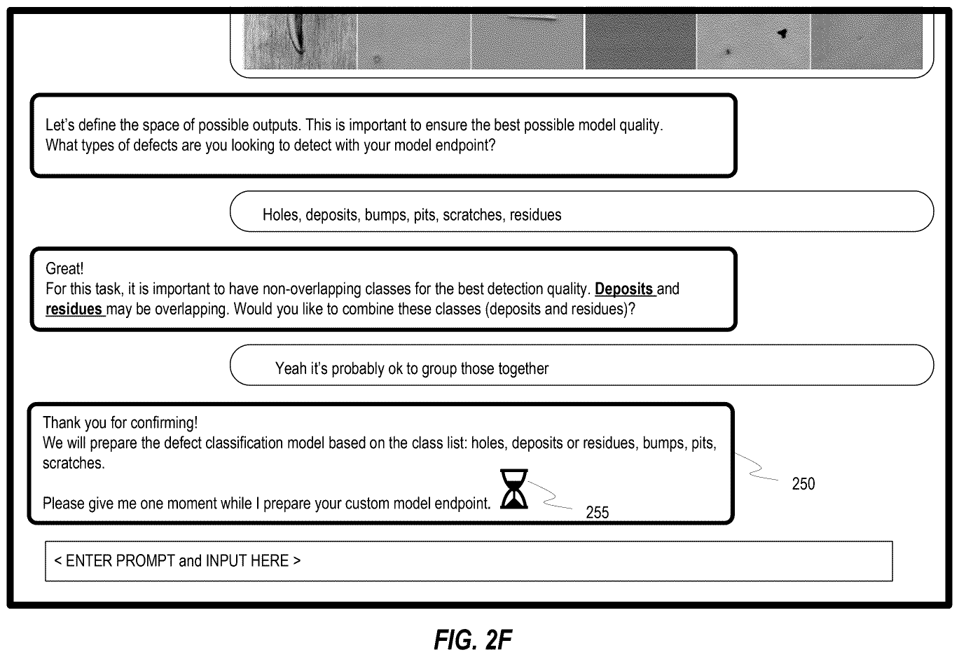

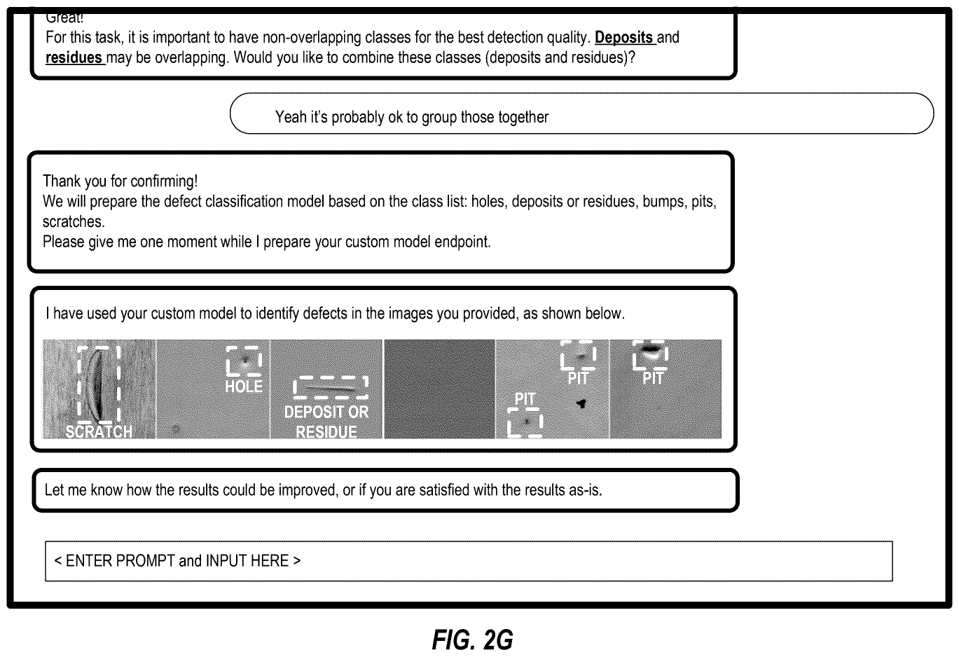

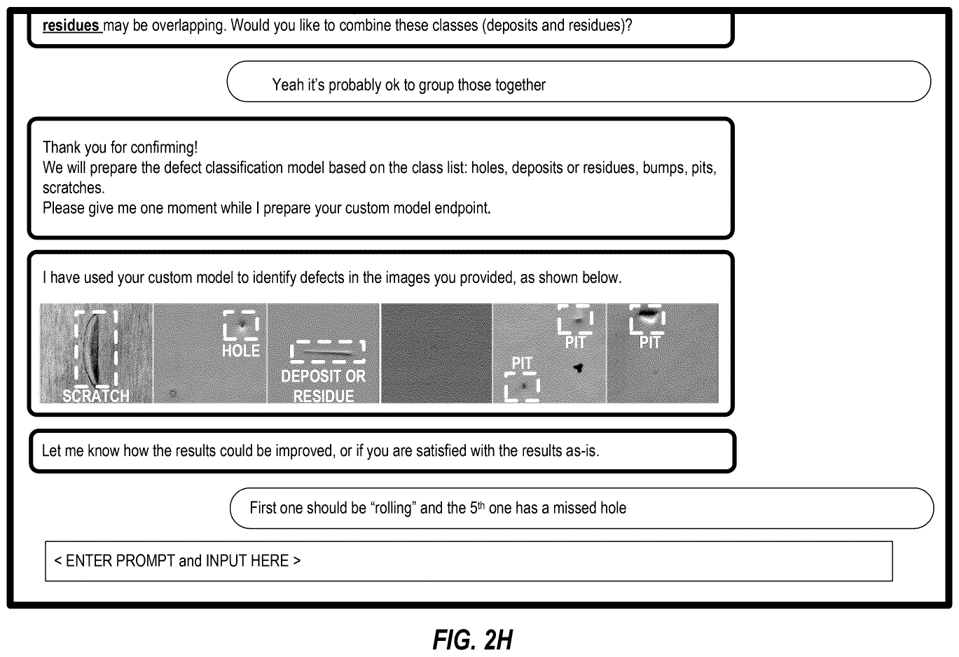

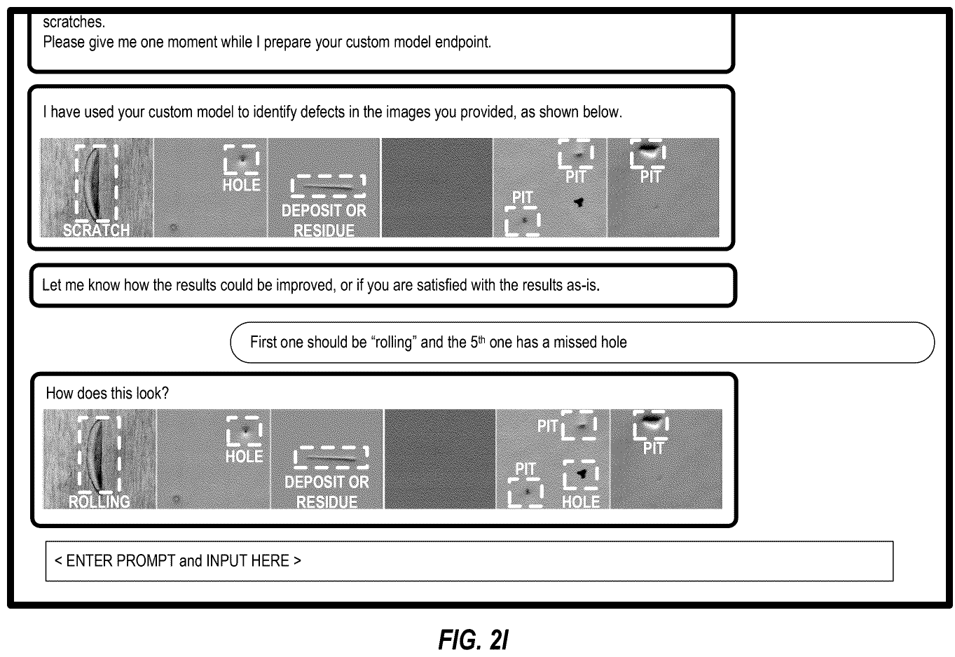

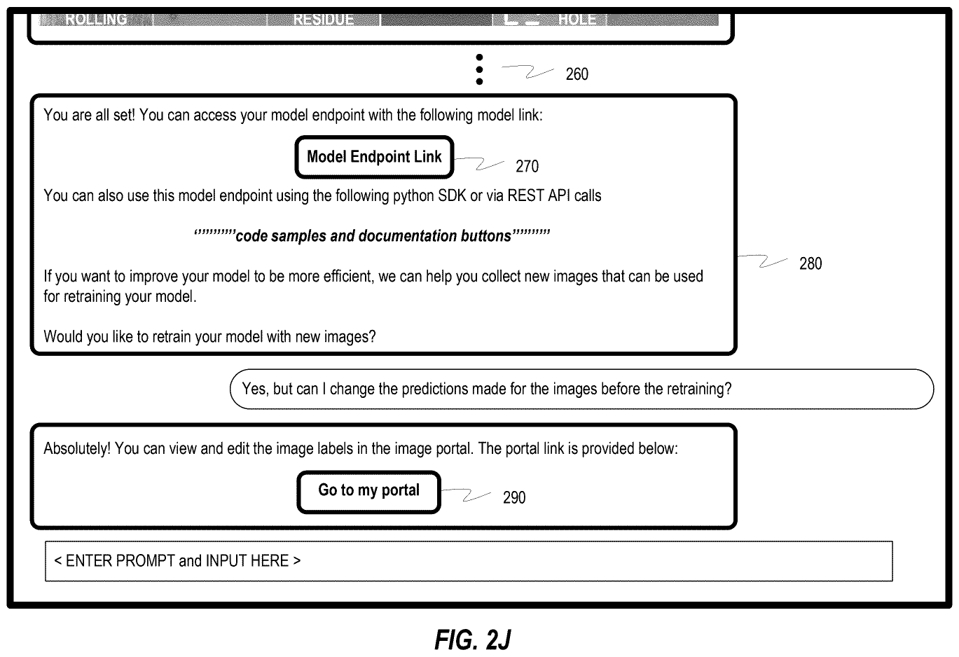

While the scope of the invention is not limited to any particular type of customized multimodal task model or task to be performed, a specific non-limiting example will now be provided in reference to interfaces shown in FIGS. 2A-2J that are associated with generating a customized vision task model and the related acts of flowchart 400.

As shown in FIGS. 2A-2J, a model customization agent engages in a multi-turn dialogue with a user for facilitating the generation of a customized multimodal task model comprising, in this example, a vision task model configured to detect flaws in the manufacture of metal products. Through this dialogue, the model customization agent is able to identify and modify task definitions based on multimodal user inputs for a selected task to be performed by a customized multimodal task model comprising an exemplary vision task model.

An inference contract for the selected task is based on the formalization of the task definition and input/output taxonomies for the selected task. Once the inference contract is established, then execution processing flows of the customized multimodal task model are created to implement the inference contract. Thereafter, execution processing flows can be modified based on user feedback directed at inferenced images to improve the functions of the customized task model.

In the current example, in which the multimodal task model comprises a vision task model, the process starts with the computing system selecting a task to be performed by the customized vision task model that is being generated through the process (act 410, FIG. 4). The selection of the task may occur in response to a user providing input to the computing system through an interface (e.g., interface 200) with different content that can be used to identify a corresponding task. For instance, in the present example, the user provides multimodal input comprising at least one image 210 (e.g., an image of manufactured metal) along with a textual description associated with a desired task (i.e., “I want to know where there is a defect in the metal on my assembly line, like this one has a defect in the middle.”) This input can be entered within input field 202 (e.g., typing text into the input field and dragging an image file into the input field). The entered input is also reflected in user dialogue box 204.

It will be appreciated that there are also different ways to enter the user input. By way of example, text input can be entered into the input field 202 as a transcript generated by the computing system in response to detecting utterances spoken into a microphone. In this regard, text input is only one example of language data that can be associated with a task and does not necessarily need to be entered as typed text.

Regardless of how the user input is entered, the computing system can identify and label the user input with correspondingly appropriate language and image processing models. For example, the computing system includes different models 190 to perform different functions, including natural language processing and image processing. The natural language processing may include voice to text speech recognition, translation, and other natural language processing.

One or more models are configured to perform natural language processing for identifying objects, actions and other terms associated with tasks. In some instances, one or more of the models are trained to specifically identify terms associated with tasks from input language data, as well as to identify context from the image data that is provided with the user input (e.g., image 210).

Different models are also trained to identify image content and to label objects identified in the images. In this manner, the computing system can leverage different model functionalities to identify, label and correlate user language input with labeled image input. The labeled input data can then be used to identify corresponding key terms for task definitions to identify contextually relevant tasks to be performed by the customized vision task model that is being generated in response to the user inputs.

In some instances, the systems store or access specific models 190 depending on the types of inputs that are received. In this regard, the referenced models 190 (shown as Model A, A′, B, C, D . . . ) can each comprise a different type of model for performing a different function related to the labeling of input data (e.g., language processing perform by Model A, object detection performed by Model B, correlation of text labels and object labels performed by Model C, the correlation of image and text input labels to stored task definitions, etc.). The models may also perform similar functions (e.g., Model A, A′, each configured to perform language processing for different spoken languages).

The model interfaces 180 can detect what types of multimodal inputs are received and select the appropriate models to use to identify the key terms associated with the user input. The process of identifying models to be used and the labeling of the input data may be an iterative process managed by the model interfaces 180.

For instance, a first process may include identifying different types of user input (e.g., spoken language input, typed language input, image inputs), and selecting the appropriate models for processing the user input, based on the different types of inputs that can be received. The processes may include for instance, identifying based on the types of input, the need to perform natural language processing with one or more language processing model(s) to transform spoken utterances into a transcript of text input and then to perform a different type of natural language processing to identify and label key terms from the text input of the transcript. Then, based on the key terms identified from the text input, the model interfaces can further be used to identify object detection models that are configured to identify and label specific objects within images that correspond to the labels generated by the language processing model(s). The model interface(s) 180 can also be used to correlate labeled text and image data with different tasks based on key terms included in task definitions for the tasks.

Once the multimodal user input is processed, either in a single input labeling step or multiple steps by one or more models, the computing system will compare the labeled input data to one or more task definitions that are stored by the computing system, which need not be an exhaustive list of all task functions, relevant terms and/or formats.

Preferably, each task definition includes attributes that define input and output formats as well as key terms that can be used to define a task to be performed. In some instances, each task definition corresponds to a discrete task and a corresponding model configured to perform the discrete task to generate outputs having output formats defined by the task definition based on inputs having input formats defined by the task definition. In other instances, multiple task definitions can correspond to a single task and a single model. In yet other instances, a single task or task definition may correspond to multiple models configured to cooperatively perform the task in a coordinated workflow, as the defined task(s) may include multiple different functions that are each performed by different models. The model interface(s) 180 can coordinate this workflow and model processing which collectively comprise the generated vision task model configured to perform a selected task according to the inference contract defined by the underlying task definitions and user inputs.

It will be appreciated that, despite the specificity of the present examples, the task definitions can also include different types of content and formats. By way of example, the task definitions can include dynamic key-value pairs that accommodate different types of multimodal inputs and types of content identified for the key-value pairs. Importantly, the referenced task definitions are not necessarily an exhaustive list of all task functions, formats of inputs and outputs, and key terms associated with the tasks. The task definitions can also be updated to include new definition content and/or to modify or replace existing task definitions based on detected new user input and new third-party input.

In some instances, when the labeled input data matches key terms for a plurality of different task definitions, the computing system will identify and select the best match between a selected/proposed task to be performed and the labeled input data based on a determined relevance of the labeled input data to the task definition of the selected/proposed task relative to the task definitions for different possible tasks.

As shown in FIG. 2B, once the system selects a proposed task from the plurality of possible tasks, the system presents an output comprising a textual description that identifies the proposed task (e.g., object detection task) with some additional information about the task definition (e.g., possible output formatting). A request is also provided for additional information from the user that can be used to formalize the taxonomy of inputs and outputs for the customized vision task model that is being generated to perform the proposed task.

In some instances, the system identifies additional information to request from the user based on the task definition corresponding to the selected task. In particular, the task definition may include a predefined list of required information (e.g., input and output types, classes, formats). This required information is needed, in some instances, to formalize the taxonomy of input and output formats for the model that will perform the selected task. Any new information provided by the user can also be used to modify a task definition for a selected task (e.g., modifying Task Definition C into Task Definition C′ and even further into Task Definition C″) and/or select a different task based on determining a different task definition is more relevant to and/or a better match with the labeled input data obtained from the user, including newly received input data responsive to prompting from the system for the required information.

The system will prompt the user until all of the required information is provided by the user. This may occur through an iterative multi-turn dialogue with the user. The system uses the referenced models to determine how to formulate prompts to the user for the required/missing information and to parse and label the user inputs to determine whether the inputs include the required information.

In the current example, as shown in FIG. 2B, the system may present icons or graphics to further facilitate the dialogue with the user. In particular, the dialogue box 206 that presents the system statement about the selected task, task definition attributes and prompt to the user is presented with an agent icon 220 to reflect that the content of the dialogue box 206 originated from the system and corresponding model customization agent. The dialogue box 206 may also be presented with different formatting than used for the user dialogue box 204. The formatting may include position, size, shape, line weight, coloring, font style, animation, contrasts and/or other formatting.

Once the system has selected the task (act 410), the system will create an inference contract for the selected task (act 420). This act includes the aforementioned act of presenting prompts to the user (e.g., at user interface 200) that identify the proposed/selected task, such as by identifying the task definition (e.g., attributes such as input and output formats and other information associated with the task definition).

The process of creating the inference contract also includes obtaining new user input that either confirms the proposed task definition is appropriate and/or that is used to modify the existing task definition for a selected task.

This foregoing process for creating and formalizing an inference contract is illustrated in FIG. 2C, as the user is prompted for additional content (new images of processed metal) associated with the selected task (e.g., defect detection in processed metal), which are provided by the user via dragging and dropping image files into the input field 202 for example, and displayed in user dialogue box 230.

To facilitate a user understanding of the prompt provided by the system, selectable controls can be provided to narrate and/or expound on what is needed. In FIG. 2D, for example, a user can select control 235 to hear a narration and/or additional information about what is needed. The output generated in response to a user selecting control 235 can be generated by the models described previously.

In the process of prompting a user for requested/necessary information, the system may prompt a user to define the classes and specific formats to be used for processing inputs and for producing outputs by the customized vision task model. Such a prompt, as shown in FIG. 2D may also be provided with visual indicators, such as agent icon 240 that is presented with a question mark to visually indicate information is needed, as identified in the adjacent dialogue box (e.g., “types of defects”).

In this example, a user provides the additional requested information by typing it into dialogue box 202.

This process continues, as shown in FIGS. 2D, 2E and 2F, until the system has determined all of the requested information has been obtained. See, for example, the system output in dialogue box 250 indicating that the system will now prepare the customized vision task model (i.e., the defect classification model).

It is also noted that during the process of obtaining the necessary/required information from the user to select a task, the system may prompt the user with suggestions for modifying the task definition for a selected task. The suggested modifications may include suggestions for identifying or modifying the formatting of the inputs and outputs to be processed by the customized vision task model.

In the current example, as shown in FIGS. 2E and 2F, the system prompts the user with the suggestion to combine two classes of defects (e.g., deposits and residues) based on one of the system models identifying that there is an overlap of the two classes based on declarations associated with the task definition for the selected task and/or by the model(s) that will be performing the actual image processing to detect the defects. The suggestions made by the system may also be based on contextual information received from the user, a user profile, usage patterns, temporal or scheduling constraints, third-party information and/or other contextual information.

The system processes the user inputs entered in response to the prompt as confirmations or rejections to the proposed task definition(s) and/or as modifications to be made to the task definition(s). In some instances, the user inputs can cause the system to select a new task and task definition that better matches the combined user inputs (e.g., based on labeled input data compared to key terms associated with the different task definitions and tasks). In this regard, the system can be highly flexible and responsive to accommodate different customer needs and preferences while identifying/selecting the tasks to be performed and while formalizing the corresponding inference contract that will be used by the system when performing the selected tasks.

During the multiturn dialogue with the user, the system may provide visual indicators reflecting the status of the system during the processing involved with preparing the customized multimodal task model. In one example, the system provides icons, such as icon 255, to reflect the system is currently processing user inputs so that the user does not come to an erroneous conclusion that the system has become non-responsive during the processing. Other icons can be presented to reflect a percentage of information that has been given relative to what is still needed so that the user can estimate additional time that may be needed to complete the process (not shown).

Through the foregoing iterative process, the inference contract is created and formalized, which defines the input and output formats, classes, functions and other task definition taxonomies that control how a task will be performed to generate desired outputs from provided inputs.

After the inference contract is created (act 420), the system generates an execution processing flow for the customized multimodal task model to implement the inference contract (act 430). This execution processing flow may include one or more graphs that identify models to be utilized and ordering of processes to be completed by the different models when completing the defined tasks. The actual graphs and model nodes of the execution processing flow graph(s) may be stored in the computing system storage. They may also be accessed through links stored by the system.

FIG. 2G indicates how the system may present outputs generated by the exemplary customized vision task model when it performs the execution processing flow defined by the inference contract. In this example, the system has presented the user's input images with box identifiers surrounding identified defects and labels that classify the different defects. The system also prompts the user to confirm whether the results are sufficient or whether there could be improvements in the classifications made.

In FIG. 2H, the user has provided some additional user input that is processed by the system to modify the task definition used for identifying and classifying detected defects and which correspondingly modifies the execution processing flow of the customized vision task model. In particular, the user has indicated that the “First one should be “rolling” and the 5^{th} one has a missed hole”. In this example, the system processes the user input, using the models previously discussed, and modifies the task definitions to include the defect classification of “rolling” and correlates the defect identified in the first image with the rolling defect label in a user image dataset.

Then, in FIG. 2I the system generates new model output with the revised execution processing flow based on the additional user input. The system also prompts the user for feedback based on the new output.

This iterative process may continue, as reflect by the ellipses 260 shown in FIG. 2J, until the user confirms that the results are adequate and which inherently confirms the proposed/revised task definition(s) for the inference contract to be used for controlling the execution processing flow of the customized multimodal task model.

After the execution processing flow for the customized multimodal task model is formalized, the system will provide the user with access to the customized multimodal task model (act 440).

In the current embodiment, the system provides model access via a selectable link to the customized multimodal task model which, when selected, instantiates the execution processing flow of the customized multimodal task model and prompts the user for content (e.g., input images) to be processed by the model to generate labeled output (e.g., output images). In the present example, the selectable link 270 is provided in dialogue box 280 which, when selected, prompts the user for input images that are processed by the customized vision task model to generate output images that are annotated to reflect the identified defects.

The system can also provide access to the generated model by presenting the user with code snippets and modules that can be used to perform API calls for accessing and utilizing the customized multimodal task model, as suggested within dialogue box 280.

In some instances, the system also prompts the user to further train the model and provides links to access the output/content (e.g., image datasets) created with the model. For example, the “Go to my portal” link 290 is operable, when selected, to trigger the system to present a stored set of images that are processed by the customized vision task model.

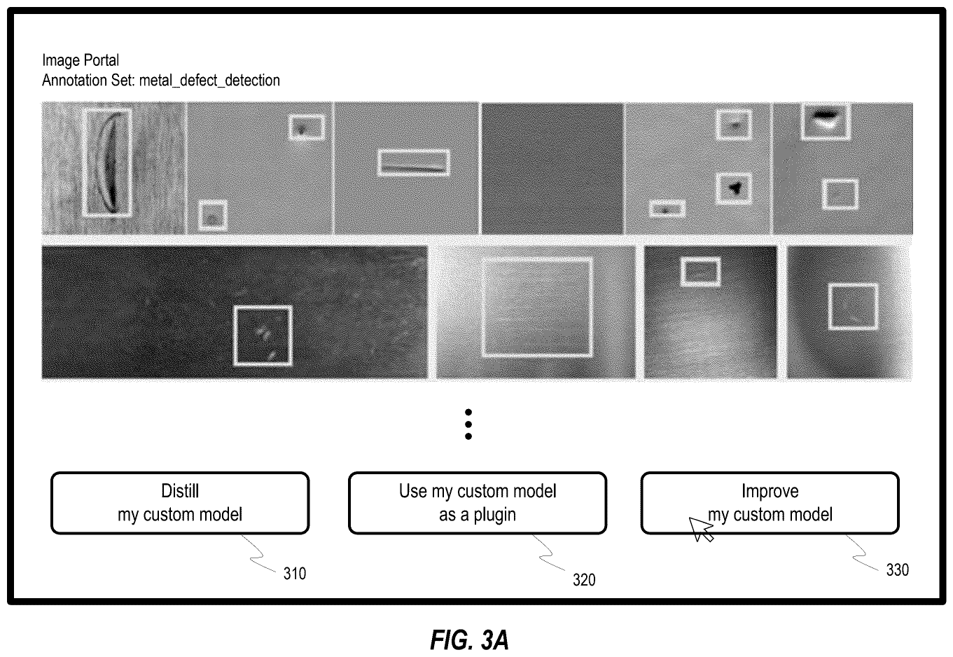

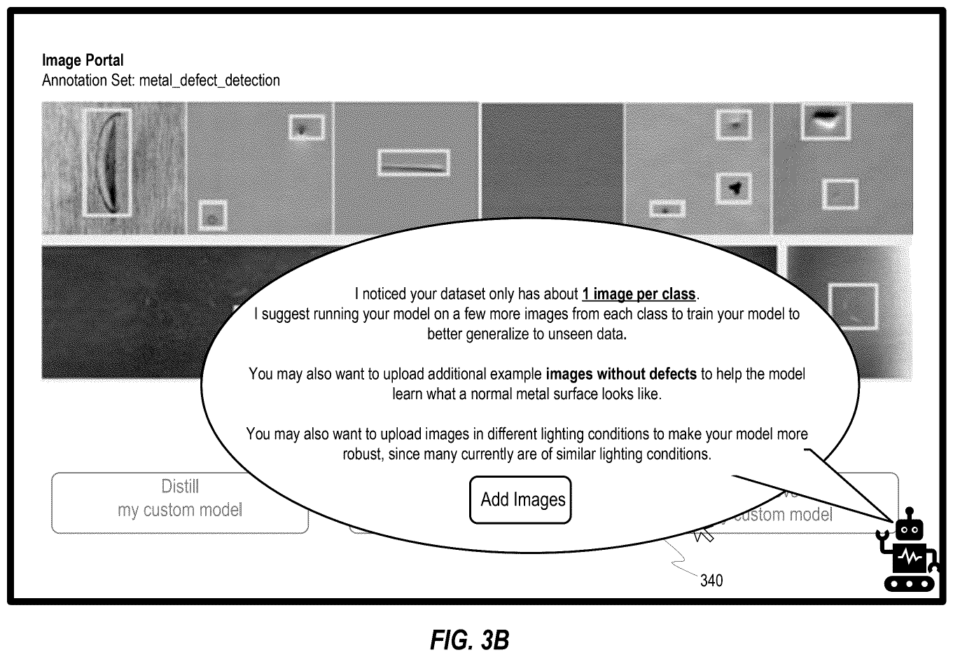

FIG. 3A illustrates an example of a user dataset of processed content i.e., Annotation set: metal_defect_detection) presented in an image portal interface. In the current example, the user dataset is presented with output images that are annotated with boxes that visually identify the location of classified defects in the images. The labels that identify the specific type or class of defect are not presented in this instance but can be in other implementations. The labels can also be provided, in some instances, by hovering a mouse prompt over the image and/or annotation box(es).

As reflected in FIG. 1, the system may store a plurality of different model outputs/content, such as image datasets Image Set A, Image Set B, Image Set C, that each correspond to different users, different tasks and/or different inferencing cycles in which the customized multimodal task model is used to perform processing on (e.g., input images) to generate the inferenced output (e.g., output images).

In some instances, the inferenced content (e.g., inferenced images) are also used to control the manner in which the customized multimodal task model processes new input (e.g., new input images), such that a user can modify the functioning of the customized multimodal task model by modifying the model content (e.g., images in the image dataset). By way of example, the execution processing flow of the customized vision task model can include the processing of images with a zero-shot image processing model that is trained or re-trained in real-time with a limited few-shot training cycle using the images contained within a particular image dataset during each instantiation of the customized vision task model.

In some instances, an image dataset or other content is presented to the user to enable the user to direct user input at the image dataset or other referenced content for modifying the image dataset or other content. By way of example, a user can select an inferenced image in the user dataset to be modified and/or deleted from the user dataset. When a user selects an inferenced image, the system can present additional information associated with the image to the user (not shown), such as the classification labels associated with the image and positioning and sizing information for the bounding boxes and other indicators used to annotate the images. The user can then select and modify that information through one or more menu options, controls and/or input fields (not shown) which are presented to the user when the user selects the information to be modified.

In some instances, the image dataset or other content is provided with one or more additional controls, such as selectable links 310, 320 and 330, which are operable when selected to cause the system to perform a function related to the customized multimodal task model. By way of example, link 310 is operable when selected to cause the system to distill the customized multimodal task model into a lightweight model that omits at least some of the processing performed by the execution processing flow of the customized multimodal task model. The customized multimodal task model can be distilled using known distillation techniques and can include, for example, using the customized multimodal task model to perform initial inferencing for an initial set of samples to generate initial outputs and fine-tuning a smaller distilled model based on the initial set of samples and the initial outputs generated by the customized multimodal task model during the initial inferencing.

The selectable link 320 is operable, when selected, to cause the system to generate and present code and/or a related link that can be utilized to implement the customized multimodal task model as a plugin in a desired application.

The selectable link 330 is operable, when selected, to cause the system to present the user with a prompt (e.g., prompt 340 in FIG. 3B) to provide new multimodal content, such as to upload additional images, to be processed by the customized multimodal task model to generate new inferenced content (e.g., new inferenced images) that can be saved to the existing user dataset or to a new image dataset, which the user can then approve or modify to provide feedback to the customized multimodal task model to adjust the weights used by the model during subsequent inferencing.

In some instances, the system generates the prompt 340 as system feedback that is determined to help the user improve their datasets based on rules-based analysis of the user dataset (e.g., statistical analysis) and/or based on an analysis of the dataset content (e.g., images), such as a machine learning analysis of the content characteristics and trends by a model configured and trained to perform that analysis (e.g., in image analysis performed by a vision model trained to analyze image characteristics and trends).

Selectable link 330 is also operable in some instances, when selected, to prompt the user to modify or delete images in the image dataset (not shown).

Additional functionality provided by the disclosed embodiments includes the use of context-free grammars and constrained output generation as managed by a post-processing module of the model outputs to guarantee the model outputs adhere to a preferred output schema defined by the task definitions. This way, regardless of the LLM used to help generate the model outputs, it is possible to ensure a customized and predictable output format.

When processing the user inputs by the customized multimodal task model to generate the model outputs, the system may also augment the user inputs with additional real and/or synthetic data inputs obtained through third-party databases and/or that are synthetically generated from models trained to generate synthetic data. In some instances, the system searches for input content databases or samples that correlate to the inputs received from the user and/or that correspond to the contexts identified from the user inputs. The additional augmented data samples are provided with the user input to achieve a predetermined threshold size or quantity of input samples (e.g., 50, 100, 200, 500, 1000, 10,000, or more than 10,000). In some examples, such as for the exemplary vision model referenced above, the system can use text-image and image-image searches to obtain new supplemental images for the user dataset based on the initial user-provided text and/or images.

As noted earlier, the disclosed methods and functionality may be performed by computing system 100, which may take various different forms and which may include and/or be in communication with one or more user systems and third-party system.

For example, computing system 100 may be embodied as a tablet, a desktop, a laptop, a mobile device, or a standalone device, such as those described throughout this disclosure. Computing system 100 may also be a distributed system that includes one or more connected computing components/devices that are in communication with computing system 100.

In its most basic configuration, computing system 100 includes various different components, such as the referenced processors. Without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computing system 500. The different components, modules, engines, and services described herein may be implemented as objects or processors that execute on computing system 100 (e.g. as separate threads).

The referenced storage system(s) may be physical system memory, which may be volatile, non-volatile, or some combination of the two. The term “memory” may also be used herein to refer to non-volatile mass storage such as physical storage media. If computing system 100 is distributed, the processing, memory, and/or storage capability may be distributed as well.

The storage system(s) may include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 100 may also be connected (via a wired or wireless connection) to external sensors (e.g., one or more remote cameras) or devices via a network defined as one or more data links and/or data switches that enable the transport of electronic data between computer systems, modules, and/or other electronic devices. For example, computer system 100 can communicate with any number of devices or cloud services to obtain or process data. In some cases, the network may itself be a cloud network (e.g., the cloud shown in FIG. 1). Furthermore, computer system 100 may also be connected through one or more wired or wireless networks to remote/separate computer systems(s) that are configured to perform any of the processing described with regard to computer system 100.

When information is transferred, or provided, over a network (either hardwired, wireless, or a combination of hardwired and wireless) to a computer, the computer properly views the connection as a transmission medium. Computer system 100 will include one or more communication channels that are used to communicate with the network. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The embodiments described are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention can also be described in accordance with the following numbered clauses.

Clause 1. A method for generating a customized multimodal task model, comprising: selecting a task to be performed by a customized multimodal task model by at least: receiving initial user input from a user, the initial user input comprising image data and language data associated with a task to be performed; generating labeled input data by performing natural language processing on the language data and image processing on the image data; and selecting the task from a plurality of possible tasks by comparing the labeled input data with indexed task definitions of the possible tasks, the indexed task definitions including task attributes including input and output formats; creating an inference contract for the selected task by at least iteratively: presenting a prompt at a user interface that identifies a proposed task definition for the selected task; and obtaining new user input that at least confirms the proposed task definition or that supplements the initial user input for modifying the proposed task definition; generating an execution processing flow of the customized multimodal task model to implement the inference contract; presenting user access to the customized multimodal task model; generating inferenced images by performing inferencing on new input images with the customized task model according to the execution processing flow; receiving user feedback based on the inferenced images; and modifying the execution processing flow based on the user feedback to improve the customized task model.

Clause 2. The method of clause 1, wherein the selected task is selected based on a determined relevance of the task definition of the selected task relative to other task definitions of other possible tasks.

Clause 3. The method of clause 1, wherein the method further includes: identifying and presenting suggested modifications to the proposed task definition based on identified contextual information.

Clause 4. The method of clause 3, wherein the method further includes modifying the execution processing flow based on user input responsive to the suggested modifications.

Clause 5. The method of clause 1, wherein the method further includes: storing the inferenced images that are generated during the inferencing in a user dataset; receiving user input for accessing the user dataset; presenting the inferenced images from the user dataset; receiving user input directed at one or more of the user dataset; modifying the execution processing flow based on the user input directed at the user dataset.

Clause 6. The method of clause 5, wherein the user input directed at the user dataset comprises input for modifying a label of an inferenced image.

Clause 7. The method of clause 5, wherein the user input directed at the user dataset comprises input for deleting an inferenced image.

Clause 8. The method of clause 1, wherein the selected task includes a predefined list of required information and wherein the method further includes iteratively prompting the user for the required information until the required information is provided by the user.

Clause 9. The method of clause 8, wherein the method further includes performing distillation of the customized task model by using the customized task model to perform inferencing for a set of samples to generate outputs and fine-tuning a smaller distilled model based on the set of samples and the outputs generated by the customized task model during inferencing.

Clause 10. The method of clause 1, wherein the inferenced images comprise the input images annotated with boxes identifying objects within the images.

Clause 11. A computing system comprising: one or more processors; and one or more hardware storage device storing computer-executable instructions which are executable by the one or more processors for causing the computing system to implement a method for generating a customized multimodal task model, wherein the method comprises the computing system: selecting a task to be performed by a customized multimodal task model by at least: receiving initial user input from a user, the initial user input comprising image data and language data associated with a task to be performed; generating labeled input data by performing natural language processing on the language data and image processing on the image data; and selecting the task from a plurality of possible tasks by comparing the labeled input data with indexed task definitions of the possible tasks, the indexed task definitions including task attributes including input and output formats; creating an inference contract for the selected task by at least iteratively: presenting a prompt at a user interface that identifies a proposed task definition for the selected task; and obtaining new user input that at least confirms the proposed task definition or that supplements the initial user input for modifying the proposed task definition; generating an execution processing flow of the customized multimodal task model to implement the inference contract; presenting user access to the customized multimodal task model; generating inferenced images by performing inferencing on new input images with the customized task model according to the execution processing flow; receiving user feedback based on the inferenced images; and modifying the execution processing flow based on the user feedback to improve the customized task model.

Clause 12. The computing system of clause 1, wherein the selected task is selected based on a determined relevance of the task definition of the selected task relative to other task definitions of other possible tasks.

Clause 13. The computing system of clause 1, wherein the method further includes: identifying and presenting suggested modifications to the proposed task definition based on identified contextual information.

Clause 14. The computing system of clause 13, wherein the method further includes modifying the execution processing flow based on user input responsive to the suggested modifications.

Clause 15. The computing system of clause 11, wherein the method further includes: storing the inferenced images that are generated during the inferencing in a user dataset; receiving user input for accessing the user dataset; presenting the inferenced images from the user dataset; receiving user input directed at one or more of the user dataset; modifying the execution processing flow based on the user input directed at the one or more of the user dataset.

Clause 16. The computing system of clause 15, wherein the user input directed at the user dataset comprises input for modifying a label of an inferenced image.

Clause 17. The computing system of clause 15, wherein the user input directed at the user dataset comprises input for deleting an inferenced image.

Clause 18. The computing system of clause 11, wherein the selected task includes a predefined list of required information and wherein the method further includes iteratively prompting the user for the required information until the required information is provided by the user.

Clause 19. The computing system of clause 18, wherein the method further includes performing distillation of the customized task model by using the customized task model to perform inferencing for a set of samples to generate outputs and fine-tuning a smaller distilled model based on the set of samples and the outputs generated by the customized task model during inferencing.

Clause 20. The computing system of clause 1, wherein the inferenced images comprise the input images annotated with boxes identifying objects within the images.

What is claimed is:

1. A method for generating a customized multimodal task model, comprising:
selecting a task to be performed by a customized multimodal task model by at least:
receiving initial user input from a user, the initial user input comprising image data and language data associated with a task to be performed;
generating labeled input data by performing natural language processing on the language data and image processing on the image data; and
selecting the task from a plurality of possible tasks by comparing the labeled input data with indexed task definitions of the possible tasks, the indexed task definitions including task attributes including input and output formats;
creating an inference contract for the selected task by at least iteratively:
presenting a prompt at a user interface that identifies a proposed task definition for the selected task; and
obtaining new user input that at least confirms the proposed task definition or that supplements the initial user input for modifying the proposed task definition;
generating an execution processing flow of the customized multimodal task model to implement the inference contract;
presenting user access to the customized multimodal task model;
generating inferenced images by performing inferencing on new input images with the customized task model according to the execution processing flow;
receiving user feedback based on the inferenced images; and
modifying the execution processing flow based on the user feedback to improve the customized task model.

2. The method of claim 1, wherein the selected task is selected based on a determined relevance of the task definition of the selected task relative to other task definitions of other possible tasks.

3. The method of claim 1, wherein the method further includes:
identifying and presenting suggested modifications to the proposed task definition based on identified contextual information.

4. The method of claim 3, wherein the method further includes modifying the execution processing flow based on user input responsive to the suggested modifications.

5. The method of claim 1, wherein the method further includes:
storing the inferenced images that are generated during the inferencing in a user dataset;
receiving user input for accessing the user dataset;
presenting the inferenced images from the user dataset;
receiving user input directed at one or more of the user dataset;
modifying the execution processing flow based on the user input directed at the user dataset.

6. The method of claim 5, wherein the user input directed at the user dataset comprises input for modifying a label of an inferenced image.

7. The method of claim 5, wherein the user input directed at the user dataset comprises input for deleting an inferenced image.

8. The method of claim 1, wherein the selected task includes a predefined list of required information and wherein the method further includes iteratively prompting the user for the required information until the required information is provided by the user.

9. The method of claim 8, wherein the method further includes performing distillation of the customized task model by using the customized task model to perform inferencing for a set of samples to generate outputs and fine-tuning a smaller distilled model based on the set of samples and the outputs generated by the customized task model during inferencing.

10. The method of claim 1, wherein the inferenced images comprise the input images annotated with boxes identifying objects within the images.

11. A computing system comprising:
one or more processors; and
one or more hardware storage device storing computer-executable instructions which are executable by the one or more processors for causing the computing system to implement a method for generating a customized multimodal task model, wherein the method comprises the computing system:
selecting a task to be performed by a customized multimodal task model by at least:
receiving initial user input from a user, the initial user input comprising image data and language data associated with a task to be performed;
generating labeled input data by performing natural language processing on the language data and image processing on the image data; and
selecting the task from a plurality of possible tasks by comparing the labeled input data with indexed task definitions of the possible tasks, the indexed task definitions including task attributes including input and output formats;
creating an inference contract for the selected task by at least iteratively:
presenting a prompt at a user interface that identifies a proposed task definition for the selected task; and
obtaining new user input that at least confirms the proposed task definition or that supplements the initial user input for modifying the proposed task definition;
generating an execution processing flow of the customized multimodal task model to implement the inference contract;
presenting user access to the customized multimodal task model;
generating inferenced images by performing inferencing on new input images with the customized task model according to the execution processing flow;
receiving user feedback based on the inferenced images; and
modifying the execution processing flow based on the user feedback to improve the customized task model.

12. The computing system of claim 1, wherein the selected task is selected based on a determined relevance of the task definition of the selected task relative to other task definitions of other possible tasks.

13. The computing system of claim 1, wherein the method further includes:
identifying and presenting suggested modifications to the proposed task definition based on identified contextual information.

14. The computing system of claim 13, wherein the method further includes modifying the execution processing flow based on user input responsive to the suggested modifications.

15. The computing system of claim 11, wherein the method further includes:
storing the inferenced images that are generated during the inferencing in a user dataset;
receiving user input for accessing the user dataset;
presenting the inferenced images from the user dataset;
receiving user input directed at one or more of the user dataset;
modifying the execution processing flow based on the user input directed at the one or more of the user dataset.

16. The computing system of claim 15, wherein the user input directed at the user dataset comprises input for modifying a label of an inferenced image.

17. The computing system of claim 15, wherein the user input directed at the user dataset comprises input for deleting an inferenced image.

18. The computing system of claim 11, wherein the selected task includes a predefined list of required information and wherein the method further includes iteratively prompting the user for the required information until the required information is provided by the user.

19. The computing system of claim 18, wherein the method further includes performing distillation of the customized task model by using the customized task model to perform inferencing for a set of samples to generate outputs and fine-tuning a smaller distilled model based on the set of samples and the outputs generated by the customized task model during inferencing.

20. The computing system of claim 1, wherein the inferenced images comprise the input images annotated with boxes identifying objects within the images.
